(19) United States
(12) Patent Application Publication
(10) Pub. No.: US 2020/0361184 A1
(43) Pub. Date: Nov. 19, 2020

(54) LIGHTWEIGHT POLYETHYLENE FILM FOR PACKAGING APPLICATIONS AND THE PRODUCT RESULTING THEREFROM AND THE METHOD OF MAKING THE SAME

(71) Applicant: MuCell Extrusion, LLC, Woburn, MA (US)

(72) Inventors: Mehdi Saniei, Belmont, MA (US); Mark E. Lindenfelzer, Milton, MA (US); Eric V. Fredrickson, Lancaster, MA (US)

(73) Assignee: MuCell Extrusion, LLC, Woburn, MA (US)

(21) Appl. No.: 16/415,233

(22) Filed: May 17, 2019

(51) Int. Cl. B32B 27/06; B32B 5/18; B32B 27/32; B32B 27/20; B32B 27/30; B32B 27/08

(52) U.S. Cl. CPC B32B 27/065; B32B 5/18; B32B 27/32; B32B 27/20; B32B 27/306; B32B 27/08; B32B 2266/08; B32B 2250/03; B32B 2307/7265; B32B 2250/246; B32B 2250/05; B32B 2439/70; B32B 2266/025; B32B 2307/546

(57) ABSTRACT

A multilayer foam film comprising high density polyethylene for direct and non-direct food contact and general packaging application is disclosed. In an embodiment, the film has a bulk density of less than 0.962 gr/cm³ wherein more than 50% of the cells in the foam layer are closed cells. In an embodiment, the foam films are thick (generally more than 8 mils thick) and have a bending stiffness value of more than 18, in Taber stiffness unit configuration according to TAPPI/ANSI T 489 om-15, and the ratio of the mass per unit area (the mass of a unit area of the film in gram per meter-squared (gr/m²)) over the stiffness value in Taber unit configuration is equal to or less than 13. In an embodiment, the film has a very smooth surface with a smoothness value of less than 25 in Sheffiled smoothness unit configuration according to TAPPI T 538. The foam film of the present invention has a water vapor transmission rate value of less than 0.05 gr/100 in²/24 hr, according to ASTM E398-13.

### FIELD

This invention relates to a multilayer foam film of high density polyethylene (HDPE) which may be used for paper replacement application in packaging industry.

### BACKGROUND

Paperboards consumption for packaging application accounts for almost one-third of the total packaging market. For the direct food contact packaging, paper boards work safely with a barrier coating of some form. Conventionally, for the food packaging applications where the barrier properties are essential, the paper boards may be paraffin wax coated or laminated with a polymer film or aluminum film where moisture and oxygen barrier properties are required. This can make a considerable recycling issue because the vast majority of the recycling sites are deficient in infrastructure that can provide a certain recycling technology. So, with the vast demand growth in food packaging in emerging markets, it would be desirable to produce a lightweight recyclable polymeric film that possesses surface quality for printing and preprinting shelf life, bending stiffness values comparable to the paperboards used in packaging, and sufficient barrier properties, all of which may be important attributes for a product to replace the kinds of paperboard currently being used in packaging industries. Moreover, the mentioned product can address the wicking issues of coated paperboards.

To the best of applicant's knowledge, no recyclable lightweight film of polyethylene has been disclosed in prior art to replace paperboards, coated paperboards, or laminated paperboards in food packaging industries that can possess all the aforementioned attributes such as high surface smoothness, enough bending stiffness, high barrier properties, relatively low coefficient of friction on the skin layer, and which can address anti-static charge issues in industrial packaging process.

### SUMMARY

A recyclable lightweight multilayer film which may be used for direct and non-direct food contact packaging application is described herein. The film can have a very smooth surface resulting in a superior printing quality, and high enough bending stiffness to replace paper boards.

In one aspect, a coextruded lightweight multilayer thermoplastic film is provided. The film comprises at least one foam layer including a plurality of cells wherein at least 10% of the cells are closed cells. The film further comprises solid layers comprising HDPE on each side of the foam layer. The film has an overall thickness equal to or greater than 8 mils, and a bending stiffness value of greater than 18 in Taber stiffness unit configuration according to TAPPI/ANSI T 489 om-15. The ratio of the mass per unit area (the mass of a unit area of the film in gram per meter-squared (gr/m2)) over the stiffness value in Taber unit configuration is equal to or less than 13.

In another aspect, a coextruded lightweight multilayer thermoplastic film is provided. The film comprises at least one foam layer including a plurality of cells wherein at least 10% of the cells are closed cells. The film further comprises solid layers comprising HDPE on each side of the foam layer. The film has an overall thickness equal to or greater than 8 mils. The film has an average Sheffield smoothness of less than 40, according to TAPPI T 538. In some embodiments, more than 50% of the cells are closed cells.

The film can have a bending stiffness value of more than 18, in Taber stiffness unit configuration according to TAPPI/ANSI T 489 om-15, wherein the ratio of the mass per unit area (the mass of a unit area of the film in gram per meter-squared (gr/m²)) over the stiffness value in Taber unit configuration is equal to or less than 13.

The film can have a surface with an average Sheffield smoothness, according to TAPPI T 538, of less than 25.

In some embodiments, the film can have a water vapor transmission rate of less than 0.05 gr/100 in²/24 hr, according to ASTM E398-13.

Other aspects, embodiments, advantages and features will become apparent from the following detailed description.

### DETAILED DESCRIPTION

The singular forms “a,” “an,” and “the” include plural referents unless the context clearly dictates otherwise.

All ranges disclosed herein are inclusive of the recited endpoint and independently combinable (for example, the range of the bending stiffness in Taber unit configuration from 18 to 100″ is inclusive of the endpoints, 18 and 100, and all the intermediate values. In the same context, for example, the overall thickness of greater than 8 mils is inclusive of the endpoint, 8 mils.)

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute value of the two endpoints. For example, the expression “from about 0.05 to about 15” also discloses the range “from 0.05 to 15”.

As used herein, the term “lightweight” refers to the bulk density value of the products described herein being less than, or equal to, the density of their solid counterpart made from the associated base virgin resin, or the density of the associated base virgin resin. In a similar context, it refers to the bulk density value of the products described herein being less than, or at least equal to, the density of the paperboards with the same thickness or with the same weight values per unit area in gr/m². For example, bulk density values of the products of this invention can be less than 0.962 gr/cm³ which is less than the density value of the associated base virgin resin of 0.962 gr/cm³, or less than the bulk density value of 0.962 gr/cm³ of its solid counterpart made from the associated base virgin resin.

The present disclosure relates to multilayer lightweight polyethylene foam film suitable to be used in a wide range of applications such as fast food packaging; packaging of dry food products such as biscuits, cookies, cereals, tea, coffee, sugar, flour, dry food mixes, chocolates, sugar confectionaries, pet food; packaging of frozen foods such as chilled foods and ice creams; backing board for fresh products such as vegetables, fruits, meat, bacon, and fishes; packaging of baked food; packaging of liquid food and beverages such as juice drinks, milk and all sorts of products derived from milk; and packaging of all kinds of laundry detergents, shampoos, and body washes; making all sorts of pouches including stand-up pouches, pet food boxes, and grocery boxes.

One of the rationales behind the production of the synthetic lightweight films described herein and material selection for paperboard replacement is to address the recyclability, and to avoid the drawbacks of using the wax-coated paper boards, metalized films, and the films and sheets with an aluminum layer all of which are either not recyclable or cannot be recycled easily; although in reality the vast majority of the consumers intuitively believe that the above-mentioned products, such as aseptically packaged milk boxes or long shelf life beverage boxes, are recyclable.

Herein a recyclable lightweight multilayer film is disclosed which comprises no less than three layers, to be a replacement for paper boards that are being used in packaging industries, for direct and non-direct food contact packaging application. The film comprises high-density polyethylene (HDPE) wherein at least one layer, excluding the solid skin layers, has a cellular structure. In some embodiments, at least 10% of the cells are closed cell; in some embodiments, more than 50% of the cells are closed cells; and, in some embodiments, more than 75% of the cells are closed cells. As used herein, a “closed cell” refers to a cell that has cell walls that completely surround the cell with no openings such that there is no interconnectivity to an adjacent cell.

Furthermore, the bending stiffness of the disclosed multilayer foamed film product could be improved over their solid counterparts to fulfill the property requirement in packaging industries. This could be done first and foremost by the inclusion of a cellular layer in the core of the multilayer film, an accurate tune and alteration of the thickness of the cellular layer as well as fine-tuning the thickness of the solid skin layers. Generally, at the same thickness, a solid film of polyethylene can hardly possess bending stiffness values that paperboards can offer. This is due to the high degree of fiber alignment in paperboard which can significantly enhance the bending stiffness. In addition, it might be due to a higher inherent stiffness of the individual fibers in the paperboard compared to the polymer chains in the polymeric film.

Additionally, with regards to the barrier properties, almost all known multilayer barrier films include a barrier layer of some forms such as a layer of biaxial oriented polypropylene, EVOH, metalized PET, or a layer of aluminum. In general, HDPE owns a relatively low water vapor transmission rate of about 0.3-0.5 (g/100 in²/24 hr). Embodiments of the multilayer foamed film products described herein can exhibit significantly higher barrier properties compared to its solid counterparts with the same value of mass per unit area (in gram per meter squared).

Also, one of the issues in industrial scale use of the polymeric packages, which can be a crucial factor in the efficient and cost-effective packaging process, is the ability of them to be de-nested quickly and freely. De-nesting problems are typically due to the friction and static charge. Embodiments of the multilayer foam films described herein can exhibit an anti-static and low friction behavior by manipulating the skin layer's structure and by the inclusion of appropriate amounts of slip agents, anti-block and anti-static agent into the solid skin layer.

One of the steps for making the disclosed product is how the bending stiffness may be controlled and enhanced by the inclusion and controlling the thickness of the core cellular layer and fine-tuning the solid skins, as well as how the surface smoothness has been enhanced significantly by adding a tiny amount of supercritical blowing agent. Moreover, how the unique structure and layer combination has resulted in a high barrier property without the inclusion of a barrier layer of any form.

In some embodiments, a blown film process may be used where the head pressure of the extruder can go high because of a very narrow gap which benefits the nucleation of cells in the foam layer. Using such a technique, the melt fracture should be avoided, and the resin should have excellent thermal stability and high enough melt strength. Typically, film manufacturers capitalize on a blend of a low-density polyethylene (LDPE) and a linear low-density polyethylene (LLDPE), while the blend is an immiscible blend in many cases, wherein LDPE improves the processing ability and ductility while the LLDPE enhances the modulus and strength. In some embodiments, all layers of the described multilayer film comprise HDPE and, in some cases, the polymeric material in one or more of these layers consists essentially of HDPE. In one embodiment, at least one layer of the multilayer film can comprise LDPE. In some embodiments, the multilayer film can be comprised of nine layers; in some embodiments, seven layers; in some embodiments, five layers, and, in some embodiments, three layers. For example, a three-layer film may comprise a foam core layer (e.g., comprising HDPE) and two solid layers (e.g., comprising HDPE), each one on respective opposite sides of the core layer. In one case, a five-layer foam film comprises a foam core layer (e.g., comprising HDPE) in the middle with two solid skin layers on each opposite side of the core layer. In another embodiment, a seven-layer foam film comprises a foam core layer in the middle. In another embodiment, the multilayer film, which can be three, five, seven, or nine layers, comprises at least one foam layer and two solid skin layers. It should be understood that other layer configurations may be possible.

In one embodiment, the process to produce the described multilayer films may utilize a very small and precise amount of supercritical gas, for example below 0.1 wt %, as a processing aid and blowing agent. Such supercritical gas may be injected into the molten polymer at a high pressure, for example greater than 34 bar, inside an efficient and effectual mixer, e.g., cavity transfer mixer, as an extension to the extruder's barrel. The supercritical blowing agent used in the process can be either nitrogen, carbon dioxide or a mixture of nitrogen and carbon dioxide. In some embodiments, the supercritical blowing agent can be introduced inside the mixing section of the extruder at the injection pressure greater than or equal to 34 bar; in some cases, greater than or equal to 70 bar; in some cases, greater than or equal to 240 bar, and, in some cases, greater than or equal to 380 bar. The temperature of the mixer could be accurately controlled within ±1° C. The inclusion of a tiny amount of gas can offer a few important advantages in the process and, for example, blown film extrusion processes. For example, the gas can reduce the back pressure which allows processing at higher throughput and can delay any bubble instability. Therefore, melt fracture could be reduced significantly. Also, the gas can enhance the processing ability of the HDPE, and to serve as a physical blowing agent with the presence of a nucleating agent in the layer that has a cellular structure. The addition of the physical blowing agent can depress the development of melt fracture due to the viscosity manipulation of the melt which may result in high surface smoothness. Hence the printing quality on the film can be improved significantly.

In general, conventional polymer processing equipment may be used to produce the films described herein. In some cases, for example, the film can be produced by the blown film process using an annular die with a die gap from 0.45 to 1.3 mm and a blow-up ratio ranging from 1.5:1 to 3.5:1. Higher blow-up ratios might result in a more balanced MD/TD (machine direction/transverse direction) orientation, which improves overall film toughness. The die geometry and specification may be manufactured according to, for example, the patent application US 2012/0228793 A1, which is incorporated by reference herein in its entirety.

Majority of the conventional PE blown films are processed using a PE blend comprising LDPE for enhancing the bubble stability. Almost all the HDPE films are made in a high stock blown film process; otherwise, the tear strength of the HDPE film deteriorates significantly. As described above, in embodiments of the methods are used for producing the multi-layer films, a supercritical gas may be injected into the melt at a precisely controlled rate, inside a transfer mixer, before entering the annular die. This unit could be controlled as a separate temperature zone with an accuracy of ±1° C. and a gas injection pressure variation below 1%. The plasticization effect of the gas can result in a viscosity change of the molten resin which would enhance the processing ability of the resin inside the annular die at a lower temperature compared to the processing temperature which is being used conventionally. Hence, a relatively stable bubble can be made inside the pocket. Then, because of the overall high specific heat capacity of polyethylene, the transverse stretch of the bubble can be delayed until the film becomes cooler, which may further enhance the bubble stability and the frost line height. This also might be beneficial in manipulating the crystallization kinetics of the skin layers to improve a few other physio-mechanical properties. The higher degree of crystallization in the skin might lower the coefficient of friction on the skin layers.

In some embodiments, the multilayer foam films described herein can be produced by the blown film process, cast film process, or other suitable method.

In some embodiments, the polymer composition of each layer may comprise some apt amounts of other additives, such as pigments, slip agents, antistatic agents, UV stabilizers, antioxidants, nucleating agents, or clarifying agents. The foam layer optionally may contain 0.05 to 15 percent by weight of an inorganic additive, an organic additive or a mixture of an inorganic and an organic additive as a nucleating agent. For example, the foam layer may contain up to about 15% by weight of talc as a nucleating agent. In some embodiments, at least one layer may include a clarifying agent at less than 1 percent by weight, such as less than 0.5 percent by weight, such as less than 0.1 percent by weight, such as less than 0.05 percent by weight. In some cases, at least one layer of the film may contain up to about 35 wt % of calcium carbonates.

In some cases, multilayer foam film can be comprised of two solid skin layers wherein one of the skin layers contains apt amount of black pigments, for example, less than 1 percent by weight, and the other solid skin layer contains apt amounts of white pigments, for example, less than 1 percent by weight. In another case, the solid skin layers of the multilayer foam film comprise less than 0.5 weight percent of an anti-blocking agent and/or less than 0.2 weight percent of an anti-static agent.

In one embodiment, the multilayer foamed film has at least one solid skin layer with a static coefficient of friction value of less than 0.4, such as less than 0.38. In another embodiment, the film has at least one solid skin layer with a dynamic coefficient of friction value of less than 0.3.

The described multilayer film, comprising at least one foam layer, may have sets of significantly improved physiomechanical properties compared to known foamed film articles as in particular the bending stiffness value of greater than 18, in some cases greater than 20, and in some cases, greater than 25, all in Taber stiffness unit configuration, according to TAPPI/ANSI T 489 om-15, wherein the ratio of the mass per unit area (the mass of a unit area of the film in gram per meter-squared (gr/m²)) over the stiffness value in Taber unit configuration is equal to or less than 13; in some cases, less than 11, and, in some cases, less than 10. In an embodiment the film can have a Taber bending stiffness value of less than 280, according to TAPPI/ANSI T 489 om-15.

The described films can have a surface with an average Sheffield smoothness, according to TAPPI T 538, of less than 100. In some embodiments, the film may have an average Sheffield smoothness of less than 50; in some cases, less than 40; in some cases, less than 30; and, in some cases, less than 15.

The multilayer foam film can have an overall thickness of greater than 8 mils, in some cases, greater than 10 mils, in some cases, greater than 13 mils, and in some cases greater than 15 mils.

In some embodiments, the lightweight film of this invention has a bulk density less than 1 gr/cm³; in some cases, less than 0.962 gr/cm³; in some cases, less than 0.94 gr/cm³; in some cases, less than 0.9 gr/cm³; in some cases, less than 0.85 gr/cm³; and in some cases, less than 0.8 gr/cm³.

In some embodiments, the foam layer of the disclosed film has a far better cellular morphology compared to the known films. For example, the foam layers of the disclosed films can have uniformly distributed cells, for example with a closed cell morphology, an average cell size of about 10-250 μm, an average cell density of about 10²-10⁹ cells/cm³, and an expansion ratio of the foamed layer from 1 to 9. In some cases the foam layer comprises more than 50% closed cells. In one embodiment, the foam layer has a substantially entirely closed cell morphology (e.g., greater than 95% closed cells).

The films described herein can have a water vapor transmission rate of less than 0.05 gr/100 in²/24 hr, according to ASTM E398-13. In one case the water vapor transmission rate of the film is less than 0.1 gr/100 in²/24 hr.

In an exemplary embodiment, the multilayer foam film, e.g., three-layer foam film, has at least one solid skin layer with a static coefficient of friction value of less than 0.4, and/or less than 0.38. In another embodiment, the film, e.g., three-layer foam film, has at least one solid skin layer with a dynamic coefficient of friction value of less than 0.3.

In some embodiments various thermoplastics can be used in at least one layer of the multilayer foam film and in the blown film process such as polyethylene (PE), polypropylene (PP), ethylene vinyl acetate (EVA), ethylene vinyl alcohol (EVOH), polyvinyl chloride (PVC), Polyvinylidene chloride (PVDC), polyamide (PA), LLDPE copolymer which include an α-olefin co-monomer such as butene, hexene, or octene; any of the resins known as TPE family such as, but not limited to, propylene-ethylene copolymer, thermoplastic olefin (TPO), and thermoplastic polyurethane (TPU).

In another embodiment, at least one layer, (e.g., excluding the outer skin layers), of the film may comprise LDPE, PP, PA, EVOH, EVA, or PVOH.

The following examples demonstrate the process of the present disclosure. The examples are only demonstrative and are intended to put no limit on the disclosure with regards to the materials, conditions, or the processing parameters set forth herein.

### Examples

Samples of multilayer HDPE film (three layers) were produced using a blown film line from Windmoeller & Hoelscher Corporation comprising one 105 mm main extruder and two identical 75 mm co-extruders. The core extruder was equipped with a supercritical gas injection unit, capable of injecting nitrogen or carbon dioxide, and a 120 mm MuCell Transfer Mixer, both from MuCell Extrusion LLC. All the films were produced by the blown film process using an annular die with a die gap ranging from 0.45 to 1.3 mm and a blow-up ratio ranging from 2.8:1 to 3.5:1. The lip of the annular die was boron nitride coated.

To characterize the bending stiffness of the film a TABER Stiffness Tester, Model 150-E from Taber Industries was used. The smoothness of the products was evaluated using a Gurley™ 4340 Automatic Densometer & Smoothness Tester. The Water Vapor Transmission Rate (WVTR) of the samples were measured using a PERMATRAN-W Model 1/50 G+ tester from AMETEK MOCON.

Table 1 contains the characterization results of the products (samples 5 to 25) were made, as non-limiting examples to elucidate this invention, as well as comparative samples 1 to 4. The samples were produced with high-density polyethylene ELITE 5960 from Dow Chemical Company, having the melt index of 0.85 dg/min and the density of 0.962 gr/cm³. In a few samples, a minor fraction of the LDPE 1321 from Dow Chemical Company with the melt index of 0.25 dg/min and the density of 0.921 gr/cm³ was used. A minor fraction of the polypropylene used in few samples was PRB 0131 from Braskem with the melt flow rate of 1.3 dg/min and the density of 0.902 gr/cm³. The calcium carbonate and talc were prepared and introduced as a highly filled masterbatch of, respectively, 80 wt % filled calcium carbonate and 74 wt % filled talc within the PE as the based carrier resin. The foamed core layer of all samples contains up to about 16 wt % talc as the cell nucleating agent wherein the optimum amount of talc in the foam layer was found up to about 12.8 wt % for the targeted application. The amount of calcium carbonate used in a few layers of some samples was up to about 38.4 wt % wherein the optimum amount of calcium carbonate in the layers was found up to about 22.4 wt % for the targeted application.

All the samples were coextruded with the total throughout of 300 to 500 kg/hr, as it is shown in table 1. The temperature of the mixing section, wherein the supercritical gas was injected, was kept at 190° C. for all the samples 6 to 25. Supercritical nitrogen was used as a physical blowing agent and was injected into the MuCell Transfer Mixer (MTM) at the concentration from 0.045 wt % to 0.065 wt %, very accurately, into the molten polymer.

Sample 1 represents a coated paperboard which is currently being used as the backing board in the packaging of the bacon. Sample 5 is a solid monolayer HDPE sample, with a thickness of 239 μm almost in the same range as that of sample 1, which could offer a much smoother surface but about ^{˜}40% less bending stiffness value than that of sample 1. Samples 3 is a three-layer HDPE film, highly loaded with 40 wt % calcium carbonates, which has a similar thickness and almost the same bending stiffness value as the sample 5 (solid reference sample) but with a higher density. All the samples 6 to 19 showed a static coefficient of friction (COF) of 0.4 whereas the skin structure of samples 20 to 25 was manipulated by the inclusion of less than 1 wt % of anti-block agent to possess a lower COF of about 0.32 to address de-nesting issues in industrial packaging lines. The skin layers of samples 20 to 25 contains up to 1% by weight of black or white color. All the skin layers' additives were introduced as a low concentrated masterbatch with the polyethylene carrier. Sample 20 and 21 have a similar value of the mass per unit area wherein the thickness control of the foam layer, as well as the skin layers in sample 21, resulted in a higher bending stiffness value comparable to that of sample 1.

Sample 23 is the solid version of sample 24 both of which have the same value of mass per unit area. The inclusion of a cellular core layer in sample 24 resulted in much higher bending stiffness and much better surface smoothness with almost 30% density reduction.

TABLE 1

| | Sample | | | | | | | | | | | | | | |
|---|---|---|---|---|---|---|---|---|---|---|---|---|---|---|---|
| | 1 | | | 2 | | | 3 | | | 4 | | | 5 | | |
| ID | Coated Paper | | | White | | | Yellow | | | WI | | | Solid Counterpart | | |
| Density (gr/cm³) | 1.07 | | | 1.18 | | | 1.01 | | | 0.922 | | | 0.962 | | |
| Thickness (um) | 254 | | | 270 | | | 243 | | | 303 | | | 239 | | |
| Basic weight (gr/m²) | 271.9 | | | 318.6 | | | 246.8 | | | 279.3 | | | 230 | | |
| Total Throughput | | | | 400 | | | 400 | | | 400 | | | 400 | | |
| Layers | | | | A | B | C | A | B | C | A | B | C | Monolayer | | |
| HDPE | | | | 60 | 60 | 60 | 60 | 60 | 60 | 60 | | 60 | 100 | | |
| 64% talc filled PE | | | | | | | | | | | 12 | | | | |
| talc % | | | | | | | | | | 0 | 7.68 | 0 | | | |
| LDPE | | | | | | | | | | | 88 | | | | |
| PP | | | | | | | | | | | | | | | |
| 80% CaCO3 filled PE | | | | | | | | | | 40 | | 40 | | | |
| CaCO3 % | | | | 40 | 40 | 40 | 40 | 40 | 40 | 32 | 0 | 32 | | | |
| Layer Thickness (um) | | | | 44 | 120 | 106 | 123 | 54 | 66 | 55 | 183 | 65 | | | |
| Throughput (kg/hr) | | | | 70.6 | 159 | 170 | 151 | 112 | 137 | 101 | 180 | 119 | | | |
| Bending Stiffness (Taber) | 21.8 | | | 14.9 | | | 14 | | | 30 | | | 13.4 | | |
| Smoothness (Sheffield) | 41.3 | | | 112 | | | 28 | | | 18 | | | 10 | | |
| Static COF | | | | | | | | | | | | | | | |
| Dynamic COF | | | | | | | | | | | | | | | |
| | Sample | | | | | | | | | | | | | | |
| | 6 | | | 7 | | | 8 | | | 9 | | | 10 | | |
| ID | 1 | | | 3 | | | 5 | | | 5A | | | 6 Solid | | |
| Density (gr/cm³) | 0.92 | | | 0.889 | | | 0.937 | | | 1.015 | | | 1.102 | | |
| Thickness (um) | 263 | | | 253 | | | 262 | | | 252 | | | 244 | | |
| Basic weight (gr/m²) | 242 | | | 224.8 | | | 245.6 | | | 255.8 | | | 268.9 | | |
| Total Throughput | 400.1 | | | 317.1 | | | 353 | | | 352.9 | | | 353.1 | | |
| Layers | A | B | C | A | B | C | A | B | C | A | B | C | A | B | C |
| HDPE | 42 | | 40 | 40 | | 40 | 42 | | 42 | 42 | | 42 | 43 | | 40 |
| 64% talc filled PE | | 20 | | | 25 | | 20 | | 20 | | | | | 25 | |
| talc % | 0 | 12.8 | 0 | 0 | 16 | 0 | 12.8 | 0 | 12.8 | 0 | 0 | 0 | 0 | 16 | 0 |
| LDPE | 10 | 50 | 10 | | 30 | | | 30 | | | 30 | | 20 | 30 | 20 |
| PP | | | | 10 | 30 | 10 | | 30 | | | 30 | | | 30 | |
| 80% CaCO3 filled PE | 46 | 30 | 42 | 48 | 15 | 42 | 36 | 30 | 15 | 36 | 15 | 30 | 32 | 15 | 25 |
| CaCO3 % | 36.8 | 24 | 33.6 | 38.4 | 12 | 33.6 | 28.8 | 24 | 12 | 28.8 | 12 | 24 | 25.6 | 12 | 20 |
| Layer Thickness (um) | 40 | 165 | 58 | 52 | 149 | 52 | 40 | 168 | 54 | 40 | 158 | 54 | 42 | 137 | 65 |
| Throughput (kg/hr) | 84.6 | 193 | 122 | 94.8 | 129 | 93.1 | 76.9 | 174 | 102 | 73.8 | 181 | 97.8 | 64.3 | 190 | 98.8 |
| Bending Stiffness (Taber) | 12 | | | 7 | | | 17 | | | 18.9 | | | 9 | | |
| Smoothness (Sheffield) | 20 | | | 32 | | | 29 | | | 26 | | | 19 | | |
| Static COF | | | | | | | | | | | | | | | |
| Dynamic COF | | | | | | | | | | | | | | | |
| | Sample | | | | | | | | | | | | | | |
| | 11 | | | 12 | | | 13 | | | 14 | | | 15 | | |
| ID | 6A | | | 6B | | | 8 Solid | | | 8C | | | 8E | | |
| Density (gr/cm³) | 0.814 | | | 0.832 | | | 1.075 | | | 0.865 | | | 0.912 | | |
| Thickness (um) | 227 | | | 225 | | | 214 | | | 282 | | | 275 | | |
| Basic weight (gr/m²) | 184.7 | | | 187.2 | | | 230.1 | | | 243.8 | | | 250.7 | | |
| Total Throughput | 357.9 | | | 400 | | | 353 | | | 400 | | | 400 | | |
| Layers | A | B | C | A | B | C | A | B | C | A | B | C | A | B | C |
| HDPE | 45 | | 40 | 45 | | 40 | 42 | | 40 | 40 | | 40 | 45 | | 45 |
| 64% talc filled PE | | 25 | | 15 | 25 | 15 | 46 | | 35 | | | | | 25 | |
| talc % | 0 | 16 | 0 | 9.6 | 16 | 9.6 | 29.4 0 | 22.4 | | 0 | 0 | 0 | 0 | 16 | 0 |
| LDPE | 10 | 30 | 10 | 10 | 30 | 10 | 10 | 45 | 10 | 30 | 45 | 25 | 53 | 45 | 40 |
| PP | | 45 | | | 45 | | | 30 | | | 30 | | | 30 | |
| 80% CaCO3 filled PE | 43 | | 35 | 28 | | 20 | | | | 28 | | 20 | | | |
| CaCO3 % | 34.4 | 0 | 28 | 22.4 | 0 | 16 | 0 | 0 | 0 | 22.4 | 0 | 16 | 0 | 0 | 0 |
| Layer Thickness (um) | 30 | 137 | 60.2 | 32.7 | 126 | 66.1 | 40 | 134 | 40 | 51 | 181 | 50 | 50 | 174 | 51.3 |
| Throughput (kg/hr) | 72.7 | 140 | 145 | 85 | 144 | 171 | 71.5 | 210 | 71.3 | 87.3 | 222 | 90.8 | 75.1 | 244 | 80.7 |
| Bending Stiffness (Taber) | 6.3 | | | 7.9 | | | 7.3 | | | 11 | | | 14.7 | | |
| Smoothness (Sheffield) | 43 | | | 37 | | | 15.4 | | | 23 | | | 127 | | |
| Static COF | | | | | | | | | | | | | | | |
| Dynamic COF | | | | | | | | | | | | | | | |
| | Sample | | | | | | | | | | | | | | |
| | 16 | | | 17 | | | 18 | | | 19 | | | 20 | | |
| ID | 9B | | | 10 | | | 11B | | | 13 | | | 13D | | |
| Density (gr/cm³) | 0.884 | | | 0.908 | | | 0.948 | | | 0.84 | | | 0.849 | | |
| Thickness (um) | 254 | | | 268 | | | 263 | | | 292 | | | 287 | | |
| Basic weight (gr/m²) | 224.5 | | | 243.3 | | | 249.3 | | | 245.3 | | | 243.8 | | |
| Total Throughput | 400.1 | | | 400 | | | 400.1 | | | 400 | | | 400 | | |
| Layers | A | B | C | A | B | C | A | B | C | A | B | C | A | B | C |
| HDPE | 51 | 45 | 48 | 55 | 50 | 56 | 65 | 50 | 66 | 65 | 50 | 65 | 65 | 50 | 65 |
| 64% talc filled PE | | 20 | | | 20 | | | 20 | | | 20 | | | 20 | |
| talc % | 0 | 12.8 | 0 | 0 | 12.8 | 0 | 0 | 12.8 | 0 | 12.8 | 0 | 0 | 12.8 | 0 | 0 |
| LDPE | 10 | 15 | 10 | 10 | 15 | 10 | | 15 | | | | | | | |
| PP | | | | | | | | | | | | | | | |
| 80% CaCO3 filled PE | 35 | 20 | 35 | 31 | 15 | 27 | 31 | 15 | 27 | 32.4 | 30 | 26 | 32.4 | 30 | 26 |
| CaCO3 % | 28 | 16 | 28 | 24.8 | 12 | 21.6 | 24.8 | 12 | 21.6 | 25.9 | 24 | 20.8 | 25.9 | 24 | 20.8 |
| Layer Thickness (um) | 41 | 172 | 41 | 45 | 178 | 45 | 45 | 173 | 45 | 43.5 | 205 | 43.5 | 42.3 | 202 | 42.3 |
| Throughput (kg/hr) | 87 | 225 | 88.2 | 85.7 | 230 | 84.6 | 84.1 | 233 | 83 | 82.9 | 236 | 81.5 | 81.3 | 239 | 79.9 |
| Bending Stiffness (Taber) | 9.2 | | | 11.7 | | | 17.1 | | | 19 | | | 18.1 | | |
| Smoothness (Sheffield) | 52 | | | 64.8 | | | 43.2 | | | 16 | | | 11.2 | | |
| Static COF | | | | 0.4 | | | 0.4 | | | 0.4 | | | 0.32 | | |
| Dynamic COF | | | | 0.33 | | | 0.33 | | | 0.33 | | | 0.28 | | |
| | Sample | | | | | | | | | | | | | | |
| | 21 | | | 22 | | | 23 | | | 24 | | | 25 | | |
| ID | 15A | | | 15B | | | 16 solid | | | 16 | | | 17A | | |
| Density (gr/cm³) | 0.816 | | | 0.81 | | | 1.134 | | | 0.82 | | | 0.768 | | |
| Thickness (um) | 304 | | | 326 | | | 230 | | | 307 | | | 309 | | |
| Basic weight (gr/m²) | 248.1 | | | 264.2 | | | 260.9 | | | 251.8 | | | 237.4 | | |
| Total Throughput | 400 | | | 400 | | | 500 | | | 500 | | | 400 | | |
| Layers | A | B | C | A | B | C | A | B | C | A | B | C | A | B | C |
| HDPE | 65 | 50 | 65 | 65 | 50 | 65 | 65 | 50 | 65 | 65 | 50 | 65 | 65 | 50 | 65 |
| 64% talc filled PE | | 20 | | | 20 | | | 20 | | | 20 | | | 20 | |
| talc % | 12.8 | 0 | 0 | 12.8 | 0 | 0 | 12.8 | 0 | 0 | 12.8 | 0 | 0 | 12.8 | 0 | |
| LDPE | | | | | | | | | | | | | | | |
| PP | | | | | | | | | | | | | | | |
| 80% CaCO3 filled PE | 29.8 | 30 | 28 | 29.8 | 30 | 28 | 29.8 | 30 | 28 | 29.8 | 30 | 28 | 28 | 30 | 28 |
| CaCO3 % | 23.8 | 24 | 22.4 | 23.8 | 24 | 22.4 | 23.8 | 24 | 22.4 | 23.8 | 24 | 22.4 | 22.4 | 24 | 22.4 |
| Layer Thickness (um) | 45 | 214 | 45 | 47.4 | 231 | 47.4 | 45 | 140 | 45 | 45 | 217 | 45 | 45 | 219 | 45 |
| Throughput (kg/hr) | 84.6 | 232 | 83.9 | 83.7 | 233 | 83 | 100 | 300 | 99.7 | 104 | 293 | 103 | 84 | 229 | 87 |

| | | | | | |
|---|---|---|---|---|---|
| Bending Stiffness (Taber) | 20.2 | 25 | 9.8 | 20.5 | 20 |
| Smoothness (Sheffield) | 12.3 | 19.3 | 35.8 | 10.7 | 19 |
| Static COF | 0.32 | 0.32 | 0.32 | 0.32 | 0.32 |
| Dynamic COF | 0.28 | 0.28 | 0.28 | 0.28 | 0.28 |

1. A coextruded lightweight multilayer thermoplastic film comprising:
at least one foam layer including a plurality of cells, wherein at least 10% of the cells are closed cells, and
solid layers comprising HDPE on each side of the foam layer,
wherein the film has an overall thickness equal to or greater than 8 mils, and a bending stiffness value of greater than 18 in Taber stiffness unit configuration according to TAPPI/ANSI T 489 om-15, and the ratio of the mass per unit area (the mass of a unit area of the film in gram per meter-squared (gr/m²)) over the stiffness value in Taber unit configuration is equal to or less than 13.

2. The film of claim 1, which has a bulk density value of less than 0.962 gr/cm³.

3. The film of claim 1, wherein the film has an average Sheffield smoothness, according to TAPPI T 538, of less than 25.

4. The film of claim 1, wherein the film has a water vapor transmission rate of less than 0.05 gr/100 in²/24 hr, according to ASTM E398-13.

5. A coextruded lightweight multilayer thermoplastic film comprising:
at least one foam layer including a plurality of cells, wherein at least 10% of the cells are closed cells, and
solid layers comprising HDPE on the opposite side of the foam layer,
wherein the film has an overall thickness equal to or greater than 8 mils, and the film has an average Sheffield smoothness of less than 40, according to TAPPI T 538.

6. The film of claim 5, wherein the film has a bulk density value of less than 0.962 gr/cm³.

7. The film of claim 5, wherein the film has an average Sheffield smoothness, according to TAPPI T 538, of less than 25.

8. The film of claim 5, wherein the film has a Taber bending stiffness value of greater than 18 according to TAPPI/ANSI T 489 om-15, and the ratio of the mass per unit area (the mass of a unit area of the film in gram per meter-squared (gr/m²)) over the Taber stiffness value is equal to or less than 13.

9. The film of claim 5, wherein the film has a water vapor transmission rate of less than 0.05 gr/100 in²/24 hr.

10. The film of claim 1, wherein the foam layer comprises an HDPE with a density of 0.94 to 0.962 gr/cm³.

11. The film of claim 1, wherein the film has a Taber bending stiffness value of less than 280, according to TAPPI/ANSI T 489 om-15.

12. The film of claim 1, wherein at least one layer contains some apt amounts of other additives to include pigments, slip agents, antistatic agents, UV stabilizers, and antioxidant.

13. The film of claim 12, wherein the film has at least one solid skin layer with a static coefficient of friction value according to ASTM D1894 of less than 0.4.

14. The film of claim 12, wherein the film has at least one solid skin layer with a dynamic coefficient of friction value according to ASTM D1894 of less than 0.3.

15. The film of claim 1, wherein the film comprises three, five, or seven layers and is produced by the blown film process using an annular extrusion die and a blow-up ratio of 1.5:1 to 3.5:1.

16. The film of claim 1, wherein a nucleating agent is used to produce a foamed layer with an average cell size of 10 to 100 μm.

17. The film of claim 16, wherein the cell density in the foam layer is 10² to 10⁹ cells/cm³′ and the film density is 0.1 to 0.9 g/cm³.

18. The film of claim 1, wherein the foam layer comprising more than 50% closed cells.

19. The film of claim 1, wherein the foam layer is comprised of a nucleating agent with a content of 0.05 to 15 percent by weight of an inorganic additive, an organic additive, or a mixture of an inorganic and an organic additive.

20. The film of claim 1, wherein at least one layer is a solid layer, comprising HDPE with a melt index of 0.02 to 20 dg/min

21. The film of claim 1, wherein at least one of the layers, excluding both outer skin layers, comprises LDPE.

22. The film of claim 1, wherein at least one layer, excluding the outer skin layers, comprises LDPE, PP, PA, EVOH, EVA, PVOH.

23. A co-extruded and/or laminated multilayer film comprising the film of claim 1.

24. An article comprising the film of claim 1.

25. The film of claim 1, wherein the film is used in packaging uses selected from the group consisting of fast food packaging, bacon board packaging; packaging of dry food products including biscuits, cookies, cereals, tea, coffee, sugar, flour, dry food mixes, chocolates, sugar confectionaries, pet food; packaging of frozen foods including chilled foods and ice creams; backing board for fresh products including vegetables, fruits, meat and fishes; packaging of liquid food and beverages including juice drinks, milk and products derived from milk; and packaging of laundry detergents, shampoos, and body washes; and pouches to include SUP, and grocery boxes.

26. A process of making the film of claim 1, wherein supercritical blowing agent is introduced, with an injection pressure of more than 240 bar at the concentration of less than 0.065 weight percent, into a molten resin inside a mixing section of an extruder during the process.

27. The process of claim 26, further comprising processing the film by blowing the film and/or casting the film, and/or extruding the film through a flat sheet die.

28. The process of claim 26, wherein the supercritical blowing agent used is either nitrogen, carbon dioxide or a mixture of nitrogen and carbon dioxide.

29. The process of claim 26, wherein the supercritical blowing agent is introduced inside the mixing section of the extruder at the injection pressure greater than 380 bar.

30-32. (canceled)
